(19) United States
(12) Patent Application Publication
(10) Pub. No.: US 2017/0075241 A1
(43) Pub. Date: Mar. 16, 2017

(54) POLYMERIZED TONER MATERIAL COMPRISING SILICON (Si) NANOPARTICLES AND PROCESS FOR ITS PREPARATION

(71) Applicant: King Abdulaziz City for Science and Technology, RIYADH (SA)

(72) Inventors: AHMED ALI BASFAR, RIYADH (SA); Saber A. Ibrahim, CAIRO (EG)

(21) Appl. No.: 14/853,228

(22) Filed: Sep. 14, 2015

(51) Int. Cl. G03G 9/08; G03G 9/09

(52) U.S. Cl. CPC G03G 9/0806; G03G 9/0904

(57) ABSTRACT

There is provided a process for preparing a polymerized toner material which comprises silicon (Si) nanoparticles. The process comprises mixing together and allowing to react: a water-based dispersion medium comprising silicon (Si) nanoparticles and at least one conventional dispersant, a polymer resin comprising one type of monomers or more, a coloring agent, and a charge control agent.

### CROSS REFERENCE TO RELATED APPLICATION

This application claims priority to ______ patent application Ser. No. ______ filed on ______.

### FIELD OF TECHNOLOGY

This disclosure relates generally to polymerized toners. More specifically, this disclosure relates to a polymerized toner material comprising silicon (Si) nanoparticles and a process for its preparation. The silicon (Si) nanoparticles used in the invention can be modified silicon (Si) nanoparticles, which are non-toxic. The process and material of the invention are less harmful for human health and the environment.

### BACKGROUND

Toner is a special type of ink used by copy machines and laser printers. Typically, toner consists of a dry, powdery substance that is electrically charged so that it adheres to a drum, plate, or piece of paper charged with the opposite polarity. Specific polymers are used in the preparation of toner materials today. A few different types of polymer are commonly used, among which the most common types are styrene acrylate, styrene copolymer, and polyester resin.

Currently, toner materials are prepared using various processes. In general, the melting-mixing process is the most known preparation process. Polymer resin and coloring agent are molten and extruded/mixed, and the mixture is crushed and classified by size to refine toner particles. However, particles of the material obtained by this process generally present a broad particle diameter distribution similar to rocks (sharp edges and irregular shapes). This leads to toners with bad geometric properties and low charge distribution.

Ogawa T. and Kawasaki K. (EP 0952495) present processes for producing a toner that are roughly divided into a grinding process and a polymerization process. In the grinding process, a synthetic resin, a colorant and optionally other additives are melted and mixed. The mixture is ground. The ground product is then classified so as to obtain particles having a desired particle diameter, thereby obtaining a toner. Similar grinding processes are disclosed in other patents, for example, U.S. Pat. No. 5,364,729 and U.S. Pat. No. 5,403,693. In the polymerization process, a polymerizable monomer composition is prepared by uniformly dissolving or dispersing a colorant, a polymerization initiator and optionally various additives such as a cross-linking agent and a charge control agent, in a polymerizable monomer. The polymerizable monomer composition thus obtained is dispersed in an aqueous dispersion medium containing a dispersion stabilizer under stirring to form minute droplets of the polymerizable monomer composition. The dispersion containing the minute droplets is then heated to subject the droplets to suspension polymerization, thereby obtaining a toner (polymerized toner) having a desired particle diameter.

Jang (U.S. 2011/0020742) discloses a process for preparing toner comprising: forming an aqueous dispersion medium comprising calcium phosphate; forming a monomer mixture of a polymer charge control agent having a weight average molecular weight of 10,000 to 20,000, pigment, and a monomer for a binder resin; dispersing the monomer mixture into the aqueous dispersion medium in the form of droplets; and polymerizing the monomer mixture dispersed in the form of droplets, wherein about 2 to 6 parts by weight of the calcium phosphate and about 0.6 to 10 parts by weight of the charge control agent are used, based on 100 parts by weight of the monomer mixture.

Woo-Cheul J. et al. (WO 2008/072919) disclose a method of coating toner particles with different toner grade additives. The coating method of Woo-Cheul J. et al. comprises: preparing toner core particles and an external additive; and coating surfaces of the toner core particles with the external additive at a temperature between 40° C. and glassification temperature (T_{g}).

Keoshkerian et al. (U.S. Pat. No. 8,013,074) disclose several processes for preparing toner particles. In a first step, anionic stabilized latexes or emulsion resins consisting of a polyester core and a polystyrene-co-acrylic acid shell are synthesized. In a second step, cationic stabilized pigment dispersions are added, and the mixture is sheared and heated up in order to obtain a binary aggregates with a small particle size distribution. After heating the aggregates to the glass transition temperature of the resin, hybrid particles of 1 to 10 μm are formed. This is a multistep process which takes up a lot of energy.

Keoshkerian et al. (U.S. Pat. No. 6,469,094) discloses a process for the preparation of polymeric particulate materials employing a free radical polymerizable monomer, a free radical initiator and a stable free radical compound. The process includes a first bulk polymerization where controlled initiation and limited or partial monomer polymerization is accomplished for the purpose of preparing a prepolymer mixture followed by a second stage miniemulsion polymerization where substantially complete monomer polymerization is accomplished. Polymers used in known resin applications usually comprise acrylic acid-containing monomers. These polymers may then be aggregated via, for example, the polyaluminum chloride (PAC) procedure. However, acrylic acid containing monomers may be difficult to incorporate into the stable free radical polymerization process, such as in combination with styrene.

Kuei-ying et al., (U.S. 2010/0055591) discloses a method for preparing a toner composition. The method comprises providing a mixture solution which includes a resin emulsion, a pigment dispersion, a wax dispersion and a dispersible polymer coagulant. The polymer is a copolymer comprising unsaturated ester monomers and amino-containing monomers where the pH of the mixture solution is controlled such as to be in a range of 4.0±0.2. The aggregation process is performed at a temperature lower than the glass transition temperature of the resin emulsion. Additionally, a fusion process is performed at a temperature higher than the glass transition temperature of the resin emulsion. Herein, the mixture solution can be prepared by the following process: mixing a resin emulsion, pigment dispersion and wax dispersion and adjusting the pH value to 8.0±0.2, followed by the addition of a dispersible polymer coagulant, to form a mixture solution including the resin emulsion, the pigment dispersion, the wax dispersion and the dispersible polymer coagulant.

Guerino G. (U.S. Pat. No. 8,034,527) discusses the binary aggregation of charged latexes obtained from a mini emulsion polymerization process. Use of oppositely charged pigment particles for the formation of toner particles is also known in the art. Emulsion aggregation of toner particles comprised of a core, wherein the core is aggregated from nanoparticles have desired encapsulated inorganic pigment. The nanoparticles have average size of about 1 nm to about 250 nm. Moreover, the emulsion aggregation toner particles contain a shell that encapsulates the aggregation core. The toner aggregate further comprises secondary amorphous nanoparticles which are compatible with the core and the shell of the previous core-shell nanoparticles.

Various processes for preparing toner materials are known in the art. These processes generally involve many steps and are thus complex and require a high energy.

There is a need for improved processes for preparing toner materials. Also, there is a need for toner materials that present good stability and that lead to high quality printing.

### SUMMARY

The present disclosure is drawn to a polymerized toner material comprising silicon (Si) nanoparticles and a process for its preparation. The process is based on emulsion polymerization and involves use of silicon (Si) nanoparticles. The silicon (Si) nanoparticles used in this disclosure can be modified amphiphilic silicon (Si) nanoparticles, which are potentially non-toxic for human. Accordingly, the process of the invention is environmentally friendly.

Several embodiments for the process and polymerized toner material of this disclosure are outlined below.

In one embodiment, this disclosure provides for a process for preparing a polymerized toner material, comprising an emulsion polymerization process involving a water-based dispersion medium which comprises silicon (Si) nanoparticles.

In one embodiment, the silicon (Si) nanoparticles are selected from the group consisting of colloidal silica (SiO₂) nanoparticles and modified amphiphilic silicon (Si) particles.

In one embodiment, the silicon (Si) nanoparticles are colloidal silica (SiO₂) nanoparticles.

In one embodiment, the water-based dispersion medium comprises a mixture of silicon (Si) nanoparticles and at least one conventional dispersant.

In another embodiment, this disclosure provides for a process for preparing a polymerized toner material, comprising a step of (a) mixing together and allowing to react: a water-based dispersion medium comprising silicon (Si) nanoparticles and at least one conventional dispersant, a polymer resin comprising one type of monomers or more, a coloring agent, and a charge control agent.

In one embodiment, the water-based dispersion medium is obtained by (a1) mixing together silicon (Si) nanoparticles and at least one conventional dispersant.

In one embodiment, the polymer resin is obtained by (a2) mixing together the monomers and a chain transfer agent.

In one embodiment, the process further comprises: (b) submitting the polymerized toner material obtained to centrifugation and decantation; and (c) drying the polymerized toner material, optionally, step (b) is performed up to eight times, preferably five times.

In one embodiment, the mixture at step (a) further comprises at least one toner additive selected from the group consisting of: polymer initiator, cross-linking agent, wax, hydrophobic silica, organic super-fine particles and enhanced alkaline medium agent.

In one embodiment, step (a) is performed under stifling, preferable mechanical stirring.

In one embodiment, step (a) is performed at a temperature of about 60-90° C., preferably about 70-80° C., more preferably about 75° C.

In one embodiment, step (a) is performed during a period of about 7-12 hours, preferably about 8-10 hours, more preferably about 9 hours.

In one embodiment, after step (a) is performed for about 1 hour, a polymer initiator is added and the reaction is allowed to continue during a period of about 6-10 hours, preferably about 7-9 hours, more preferably about 8 hours.

In one embodiment, the silicon (Si) nanoparticles are selected from the group consisting of colloidal silica (SiO₂) nanoparticles and modified amphiphilic silicon (Si) particles; and the at least one conventional dispersant is selected from the group consisting of a fatty acid, sodium dodecyl sulfate, sodium lauryl sulfate, sodium olate, alpha olefin sulfonate, an alkylsulfate ester salt, an alkyl aryl sulfate ester salt, a dialkyl sulfosuccinate and an alkyl phosphate.

In one embodiment, the monomers at step (a) are selected from the group consisting of acrylate, n-butyl acrylate, methyl acrylate, ethyl acrylate, isobutyl acrylate, glycidyl methacrylate, 2-ethylhexyl acrylate, methacrylate, methyl methacrylate, ethyl methacrylate, n-butyl methacrylate, isobutyl methacrylate, dodecyl methacrylate and 2-ethylhexyl methacrylate.

In one embodiment, the coloring agent at step (a) is selected from the group consisting of carbon black and carbon nanotube.

In one embodiment, the charge control agent at step (a) is selected from the group consisting of positive charge control agent and negative charge control agent.

In one embodiment, at step (a), a ratio of the silicon (Si) nanoparticles to the at least one conventional dispersant in the water-based dispersion medium is about 1:1.1-1.6, preferably about 1:1.1-1.3, more preferably about 1:1.2.

In one embodiment, at step (a), an amount of the water-based dispersion medium is about 0.1-15 wt % of the monomers; an amount of coloring agent is about 1-10 wt % of the monomers; and an amount of charge control agent is about 0.1-7 wt % of the monomers.

In another embodiment, this disclosure provides for a polymerized toner material obtained by a process which comprises a step of (a) mixing together and allowing to react: a water-based dispersion medium comprising silicon (Si) nanoparticles and at least one conventional dispersant, a polymer resin comprising one type of monomers or more, a coloring agent, and a charge control agent.

Other features will be apparent from the accompanying drawings and from the detailed description that follows.

### BRIEF DESCRIPTION OF DRAWINGS

Example embodiments are illustrated by way of example and not limitation in the figures of the accompanying drawings, in which like references indicate similar elements and in which:

FIG. 1 illustrates a particle of a polymerized toner material.

FIG. 2a, FIG. 2b and FIG. 2c present scanning electron microscope (SEM) micrographs of polymerized toner particles of this disclosure (Example 1).

FIG. 3a and FIG. 3b present scanning electron microscope (SEM) micrographs of polymerized toner particles of this disclosure (Example 2).

FIG. 4a and FIG. 4b present scanning electron microscope (SEM) micrographs of polymerized toner particles of this disclosure (Example 3).

Other features of the present embodiments will be apparent from the accompanying drawings and from the detailed description that follows.

### DETAILED DESCRIPTION

In order to provide a clear and consistent understanding of the terms used in the present disclosure, a number of definitions are provided below. Moreover, unless defined otherwise, all technical and scientific terms as used herein have the same meaning as commonly understood to one of ordinary skill in the art to which this disclosure pertains.

The use of the word “a” or “an” when used in conjunction with the term “comprising” in the claims and/or the description may mean “one”, but it is also consistent with the meaning of “one or more”, “at least one”, and “one or more than one”. Similarly, the word “another” may mean at least a second or more.

As used herein, the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

As used herein, when referring to numerical values or percentages, the term “about” includes variations due to the methods used to determine the values or percentages, statistical variance and human error. Moreover, each numerical parameter in this application should at least be construed in light of the number of reported significant digits and by applying ordinary rounding techniques.

As used herein the terms “dispersant”, “emulsifier” and “surfactant” are used interchangeably to refer to a compound that lowers the surface tension or internal tension between two liquids or between a liquid and a solid.

The present disclosure is drawn to a polymerized toner material comprising silicon (Si) nanoparticles and a process for its preparation. The process is based on emulsion polymerization and involves use of silicon (Si) nanoparticles. The silicon (Si) nanoparticles used in this disclosure can be modified amphiphilic silicon (Si) nanoparticles, which are potentially non-toxic for human. Accordingly, the process of the invention is environmentally friendly.

Novel processes for preparing spherical toner particles by polymerization were created that attempt to overcome problems encountered in known processes. Suspension and emulsion polymerization techniques are generally applied as toner preparation processes when it is desired to obtained particles having well-defined shape. It is known that emulsion polymerization is a more advanced process than suspension polymerization for preparing polymerized toner particles with spherically controlled shape. For example, Zhen L. et al. (U.S. Pat. No. 7,727,696) disclose an emulsion polymerization process for preparing dry toner particles involving a toner resin and a colorant. The resin used by Zhen L. et al. is a copolymer from styrene, n-butyl acrylate copolymer, or a styrene butadiene copolymer.

This disclosure relates to a polymerized toner material with high hygiene. Indeed, a non-toxic surfactant is used. Such non-toxic surfactant can be modified amphiphilic silicon (Si) nanoparticles, for example of Ludox-group. Generally, surfactants used in such materials are harmful chemical surfactants. This disclosure leads to a complete formulation of dry toner with high pigment content. More particularly, this disclosure relates to highly precise toner particles, uniformly distributed spherical particles. Accordingly, the polymerized toner of this disclosure produces better image resolution and color accuracy, for increasing printing efficiency with low fusing temperature and gamut range properties. This disclosure leads to the preparation of a less harmful dry toner according to the World Health Organization (WHO) standards for industrial products.

A new polymerization technique known as emulsion aggregation (EA) polymerized toner technology represent a breakthrough in the field of toner materials. This new technology is environmentally friendly and unique in that it allows for color printing more accurately and affordably. Key advantages of EA technology are the ability to control the size, shape, and structure of the particles, leading to improved print quality, less toner usage, less toner waste and lower energy usage for manufacturing toner and using it in printing. This new technology enables production of toner using 25-35 percent less energy/lb of toner. Combined with 40-50 percent less toner needed during printing, EA emulsion polymerization technology offers an estimated 60-70 percent energy saving per printed page. EA emulsion polymerization technology produces less waste and enables longer life machine parts. EA emulsion polymerization is a water-based process which is environmentally friendly.

On a computer screen, more small pixels produce sharper images. This is similar with the toner used to form the picture printed on a copier or laser printer: smaller particles lead to sharper images with less toner usage. But as toner particles become smaller, the cost of making them by conventional technology rises exponentially. Recently, many researchers realized that toner made by their current technology had just about reached the lower limit in size to be cost effective, and they started looking for a new way to make it.

Toner is a mixture of plastic resin, colorant and other toner ingredients. Nowadays, most toner is made by “melt mixing” the ingredients into strands that are pulverized into small particles. Such process is both inexact and energy intensive. Because the particles are smashed at random, their size cannot be precisely controlled. Some are too big and others too fine, so they are mechanically sorted to achieve required toner size and size distribution. Such process is similar to sifting dust. The process produces toner with average size greater than 7 microns in diameter; however, it appears that attempts to make the size smaller are not economically viable.

The EA technology came as the needed breakthrough in attempting to solve this challenge in the preparation of toner materials. The EA technology utilizes sophisticated chemical design and control based on nanotechnology methodology to generate micron-sized particles in a bottoms-up approach from nanoscale components.

In the development of this technology, work was faced with significant chemistry and chemical engineering challenges. The process began with emulsion polymerization to generate nanometer scale polymer particles in water.

Coming back to emulsion polymerization, although it is a method that has been known for many years, the particular application to toner required extensive research, since this field is far outside the fields normally explored and used in most applications. In the toner field, much lower molecular weights were required. Also, it was necessary to incorporate critical components to enable a controlled agglomeration of latex particles with pigment particles in the second step of the process. A novel approach using semi-continuous emulsion polymerization was developed to specifically design lower molecular weight polymers. In addition, the polymer resin properties and functionality had to be carefully designed to enable functional performance in the steps of development and fusing.

After that, the process is the aggregation and coalescence of the latex particles with pigment and wax particles to generate the micron size toner particles in water. Understanding the kinetics of particle aggregation is critical to control the particle size distribution. Breakthroughs have been made in identifying the reagents and conditions that yield the best control of particle aggregation and precision structure design. From an engineering perspective, the invention and development of the complex aggregation/coalescence process entailed the simultaneous control of diffusion, electrostatic and mechanical shear characteristics of a highly heterogeneous system comprised of nano-sized polymeric and pigment particles. The presence of a third low molecular weight component with different visco-elastic properties required a rigorous control of the heat transfer characteristics of the system. The scale-up of the process involved the severe challenge of maintaining kinematic, dynamic and chemical similarities across all process steps in this highly complex system. The EA technology can lead to round or potato-shaped toner particles with diameters ranging from 3-10 microns. The process is water-based and thus avoids the use of organic solvents commonly used to make particles in this size range.

### High Performance Polymerized Toner as an Environmentally Friendly Technology.

As indicated above, the key advantages of the EA technology are the ability to control the size, shape and structure of the particles, which leads to improved print quality, less toner usage, less toner waste and lower energy usage for manufacturing toner and using it in printing. The EA technology offers an estimated 60-70 percent energy saving per printed page and less greenhouse gas generation compared to conventional toner. In addition, the EA technology produces less waste and is water based process which is an environmentally friendly process.

In the EA technology, the manufacturing process requires approximately 25 percent less energy per pound of toner and generates less waste compared to the conventional method of manufacturing toner. Also, the smaller toner size leads to 40-50 percent less toner per printed page. One hundred grams of conventional toner are needed to produce 1000 prints. With the EA technology, only 50-60 grams per 1000 prints are needed.

The EA technology allows for a reduction of the amount of energy associated with printing. The greater latitude in resin design enables image fixing capability at lower temperatures, thus further reducing per-page product energy consumption. The EA technology enables the use of lower melt resins, since brittle materials are not required in the fabrication process. This translates into less energy to print since the temperature of the fusing subsystem can be reduced. The more uniform size and smooth shape of the toner ensures better performance in the print engine, resulting in significantly less toner waste in the machine and its lower mass results in less waste when the image is discarded.

Toner materials obtained by the EA technology have particles with small size, circular shape and narrow size distribution. The quality of the document is thus improved as advanced image resolution and better image homogeny are obtained. Also, printer reliability is improved, which decreases machine downtime and reduction of overall costs. Moreover, the life and reliability of the fusing subsystem is improved by using the EA technology. The EA technology has enabled the use of lower melt/non-brittle resins. As a result, the fuser roll temperature can be reduced, thereby increasing the life of the machine. This also leads to longer fuser life meaning fewer replacements and fewer parts for disposal. Most laser printers require a unit that delivers oil to heated rollers that fuse the toner to the paper. The ability to incorporate wax and control its location within the toner particles using the EA technology enables oil-less fusing. The elimination of the oil offers cost advantages and improves the overall quality of the printed image. This simpler system leads to fewer parts and less possibility for part replacement and disposal.

The formation of structured polymeric nanoparticles and the encapsulation of a solid or liquid, an inorganic or organic, or a hydrophobic or hydrophilic material into a polymer shell is of great importance for many applications. Many different materials, such as organic and inorganic pigments, magnetite, or other solid nanoparticles for functional coatings and other applications, can be encapsulated in a polymer shell. Compared to polymerization processes in organic solvents, polymerization to obtain polymeric nanoparticles can be performed in environmentally friendly solvents, such as water.

There are several hetero-phase processes that allow the formation of nanoparticles in water, among which the most well-known process is emulsion polymerization, which is used in many industrial applications. However, emulsion polymerization technique is mainly used for radical polymerization, and is not well-suited to the encapsulation of preformed polymeric or inorganic materials. The mini emulsion polymerization process is a versatile technique for the formation of a broad range of polymers and structured materials in confined geometries.

By using the mini emulsion polymerization technique, nanoparticles that are more hydrophobic than the monomer can be dispersed in the monomer phase without any former treatment, as showed for the polystyrene encapsulation of organic pigments or carbon-black particles.

A new route for the production of polymer-encapsulated hydrophobic particles has been developed that is also based on mini emulsion processes. The co-sonication of two separately prepared dispersions, namely, the nanoparticle dispersion and monomer mini emulsion, followed by a polymerization, leads to effective particle encapsulation.

Monomer mini emulsion droplets and the hydrophobized material are dispersed separately. The application of high shear leads to the formation of droplets incorporating the hydrophobized material by fusion and fission processes. After subsequent polymerization, hybrid particles are obtained. Using this method, hydrophobic carbon black particles or other pigments can be encapsulated by polymers (e.g. polystyrene, polyacrylates, polyurethanes . . . etc.) efficiently, and the ratio of carbon black to polymer can vary over a wide range. The polymerization can be described as polymerization in an adsorbed monomer layer created and stabilized as a mini emulsion.

Toners are a type of typical hybrid materials comprising both organic and inorganic materials. There are some 10 μm particles made of a polymer resin binder with several pigments, including carbon black as an inorganic material, surrounded by nano-meter size super fine inorganic particles such as metal oxides. Spherical particles toners have been developed by suspension and emulsion polymerization as non-magnetic toners. These toners have many superior features over conventional pulverized toners. Such features include simpler production process, narrower particle size distribution, higher flow ability and transfer ratio, better quality of printing images and lower temperature fusing with encapsulated toner. These features allow for printers to meet not only high quality but environmentally friendly design. Since further higher resolutions and lower fusing temperatures are required in the market, especially in color toners, suspension polymerized toners are going to play more significant rolls in the near future.

Toner, the developer used in electrophotographic plain-paper copy machines and laser printers, is made up of pulverized materials having a particle diameter of approximately 10 μm. Recent advances in the electrophotographic processes using toner have been dramatic. With the recent widespread use of personal computers, particularly in the area of laser printers and digital composite machines, development is focusing on smaller size, higher image quality, higher resolution and energy savings. Environmental issues are also a main consideration in the development and improvement of these machines. The development of a toner having performance superior to that of conventional products is eagerly awaited. Most toners are generally manufactured by a milling process in which various chemicals are fused and kneaded in a pre-adjusted binder resin, and then pulverized and classified. However, because the ultra-fine particles are pulverized mechanically, the uniformity of the particles is limited. Polymerized toner was developed to address the need for highly uniform toner particles.

This disclosure relates to the preparation of toner based on new clean technology called polymerized toner technology. Practical problems of commercial toner are high energy consumed during production and low printing efficiency of resulted conventional toner. Most of commercial toners are still manufactured with conventional path way which added high harmful for human health and environment.

To find a substitute toner type we used emulsion polymerization system to encapsulate the coloring agent (pigment) as a main component of toner. In addition, combining both edible emulsifier (silicon (Si) oxide) and SDS which normally used in preparation of polymerized toner is a main aspect of this invention.

Common types of emulsifier (SDS, SLS, SOL, etc.) have a toxic effect for human user. This disclosure relates to the use of modified silicon (Si) oxide nanoparticles as a substitute to common dispersants or emulsifiers or surfactants. Modified silicon (Si) oxide nanoparticles have been approved as edible emulsifiers by the Food and Drug Administration (FDA), and are already used in some food emulsions. This disclosure allows for the preparation of unique formulations which use modified silicon (Si) oxide nanoparticles instead of SDS only. The eco-friendly process of this disclosure allows for a high control of particle size and is suitable for preparing materials for use in enhanced laser printer.

This disclosure relates to three main points illustrated as follows: firstly, an improved process for the production of polymerized toner material. More specifically, a one-step polymerization reaction involving polymer resin, pigment, charge control agent and other additives. A wide and extend group of selected monomers are used in preparation of polymer resin, which acts as carrier for the others toner additives. Styrene, styrene derivatives, acrylate and acrylate derivatives monomers constitute a main based monomer group investigated in this invention to support the selection for hard and soft segment to verified targeted glass transition temperature (Tg) for prospected polymerized toner. Different compositions were examined by combining various monomers with many odds to select highest polymerization reactivity toward other and verify the designed Tg for final printing temperature.

Secondly, numerous types of fine carbon black (CB) as (NIPEX-series) or commercial grades are used in encapsulation polymerization reaction within a range from about 1-30 wt % of the monomers. Inhibition of the polymerization process in the presence of CB has been reported in the art. The effect of monomers reactivity and degree of polymerization were evaluated in the presence of different types of CB. Encapsulation efficiency with different ratios of CB is also considered for final mark of each encapsulation system to be applied as well-fitted coloring agent.

Thirdly, charge control agent (CCA) is a main component in toner formulation after polymer resin and coloring agent. The CCA is used within a range from about 0.1-2 wt % of the monomers. This disclosure relates to laboratory and commercial types of CCA with positive and negative overall charge. In addition, new designed CCAs (not yet used in toner industry) are also used in the preparation of polymerized toner synthesis system to compare their efficiency with the efficiency of tradition CCAs. Statistical estimation of the effects of CCA on the monomers reactivity and degree of polymerization were evaluated in the presence of different types of CCA. Moreover, charge type of CCA has direct effect on degree polymerization and encapsulation efficiency, especially in the presence of different types of CB with a range of pH value from acidic to alkaline medium.

The present disclosure is further described in detail below with reference to the experiments conducted. However, the examples outlined are only for the understanding of the disclosure and the disclosure is not limited to or by these examples.

### Experiments

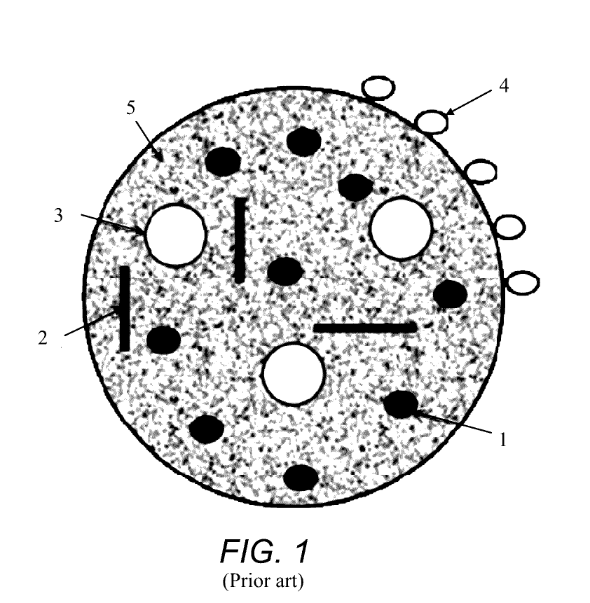

In general, the following four items are properties by which toner functions are measured: coloring matter, charge control agent, wax and inorganic matter. FIG. 1 illustrates a particle of a polymerized toner material. In order to provide toner functions, a toner contains, within polymers of approximately Tg 60-85° C. as the binder element (5), coloring matter such as carbon black for color black (1), electrically-chargeable control agents (2), wax (3) to add the releasing property with a fixed roll, and to add fluidity, minute inorganic matter such as hydrophobic silica and organic super-fine particles (4), generally attached to the exterior surface of the toner particle.

This disclosure provides for a one-step preparation process involving all toner components. The toner material of the invention has low temperature fusing property. The process has superior developing property in that emulsion particles size is controlled.

This disclosure also provides for a toner material prepared by emulsion polymerization using an aqueous-based dispersant. The amount of the aqueous-based dispersant used is about 1-20 wt % of the monomers.

Different types and derivatives of an aromatic vinyl monomer, an acrylate monomer, a methacrylate monomer, a diene monomer or a mixture thereof can be used. Optionally, an acid or basic olefin monomer is used.

In general, 1-40 parts by weight, per 100 parts by weight of an aqueous based dispersion, of a monomer mixture comprising 30-95 parts by weight, per 100 parts by weight of the total monomers, of an aromatic vinyl monomer; 5-70 parts by weight, per 100 parts by weight of the total monomers, of at least one monomer selected from a group consisting of an acrylate monomer, a methacrylate monomer and a charge control agent; 0.001-8 parts by weight, per 100 parts by weight of the total monomers, of a chain transfer agent to control the molecular weight; and 0.01-5 parts by weight, per 100 parts by weight of the total monomers, of a polymerization initiator is mixed with 100 parts by weight of an aqueous based dispersion.

The polymerization process is performed while applying shear force to the resultant mixture using a homogenizer (ultra-turrax) to prepare a toner core shell. Basically, 1-10 parts by weight of at least one polar polymer selected from a group consisting of styrene or styrene derivatives-acrylate can be added to the monomer. For the aromatic vinyl monomer, styrene, monochlorostyrene, dichlorostyrene, monobromostyrene, methylstyrene, dimethylstyrene, di methoxystyrene and vinylbenzyl chloride can be used. The aromatic vinyl monomer is comprised in 35-90 parts by weight per 100 parts by weight of the total monomers.

In addition, the acrylate monomer, n-butyl acrylate, methyl acrylate, ethyl acrylate, isobutyl acrylate, glycidyl methacrylate, 2-ethylhexyl acrylate, etc. can be used. Also, the methacrylate monomer, methyl methacrylate, ethyl methacrylate, n-butyl methacrylate, isobutyl methacrylate, dodecyl methacrylate, 2-ethylhexyl methacrylate, etc. can be used. One of the acrylate monomer and methacrylate monomer are comprised in 5-60 parts by weight of per 100 parts by weight of the total monomers.

Selection of a suitable surfactant is an important factor in the development of the emulsion polymerization process. It is desirable that the surfactant enables a fast rate of polymerization, minimize coagulum or fouling in the reactor, prevent an unacceptably high viscosity during polymerization.

Anionic, nonionic, and cationic surfactants may be used, although anionic surfactants are by far most prevalent. Surfactants with a low critical micelle concentration (CMC) are favored; the polymerization rate shows a dramatic increase when the surfactant level is above the CMC, and minimization of the surfactant is preferred for economic reasons and the (usually) adverse effect of surfactant on the physical properties of the resulting polymer. Mixtures of surfactants are often used, including mixtures of anionic with nonionic surfactants.

Modified amphiphilic silicon (Si) nanoparticles of Ludox-group for example, instead of chemical harmful surfactants are used in the aqueous-based dispersant. Ludox HS40, HS40, LS30, LS40, SM40, SM30, AM30, TM40, etc. are examples of Ludox group members as modified particles which may be used as dispersing agent. A wide range of Ludox group members was selected to cover a range of pH value that is compatible in specification with the coloring agent and the charge control agent.

Examples of surfactants commonly used in emulsion polymerization include fatty acids, sodium dodecyl sulfate, sodium lauryl sulfate, sodium olate and alpha olefin sulfonate. In addition, an alkylsulfate ester salt, an alkyl aryl sulfate ester salt, a dialkyl sulfosuccinate, an alkyl phosphate, etc. may be used as emulsifying agent for selected monomer mixture. The amount of the water-based dispersant (mixture of conventional dispersant and Ludox silica particles) is about 0.5-15 wt % of the monomers.

Different types of reaction initiator, an oil-soluble initiator or a water-soluble initiator may be used. Specially, an azo-initiator like azobisisobutyronitrile (AIBN), 2,2′-azobis(4-methoxy-2,4-dimethyl valeronitrile), 2,2′-azobis(2.4-dimethyl valeronitrile), dimethyl 2,2′-azobis(2-methylpropionate), etc. can be applied in polymerization medium. In addition, an organic peroxide initiator as benzoyl peroxide, lauroyl peroxide, t-butyl hydroperoxide, cumene hydroperoxide, paramethane hydroperoxide, benzoyl peroxide, tert-butyl peroxide, cumyl peroxide or a commonly used water-soluble initiator like potassium persulfate, ammonium persulfate, etc. may also be used with relative mixture of selected monomers. The amount of reaction initiator is about 0.01-4.00 wt %, preferably about 0.2-2.0 wt % of the total monomers.

Two categories of colorants suitable for the toner formulations are pigment and dye. An inorganic pigment such as metal powder, metal oxide, carbon black such as REGAL 330, benzoimidizolone and ferrocyanide, may be used. And an organic pigment such as acidic dye, azo-chromium complex dye, basic dye, mordant dye and dioxin or a mixture thereof may be used. The coloring agent is used in an amount of about 1-10 wt % of the monomers.

Good dispersion, high color strength, light fastness and coloring transparency are key properties of a coloring agent suitable for use in toner formulations. In addition, chemical stability and non-toxicological of applied coloring agents are important to design toner formulation.

Internal charge control agent performs many functions in toner formulation. It controls the charge type of toner particles, positive or negative, which affects the technical process of printing mechanism.

Compatibility of charge control agent (CCA) with polymer resin and the ability to create homogeneous distribution are the vital properties to consider when selecting a CCA for a toner formulation. The whole properties of CCA such as dielectric and crystallinity play an essential role in the charging of toner.

A positive charge control agent is a nigrosine type electron acceptor dye, long chain aliphatic metal salt, quaternary ammonium salt, alkylamide and naphthalenic acid metal salt. Negative charge control agent as an electron acceptor organic complex, chlorinated parafin, chlorinated polyester and sulfonated polystyrene-acrylate can be used. In addition, novel types of CCA (MEC-84C, MEC 84C & MEC 84s and MEC 91) were added to polymerized toner formulas. Generally, the charge control agent is used in an amount of about 0.1-7.0 wt % of the monomers.

The monomers are mixed with water to form an emulsion. The emulsification is generally achieved at a temperature range from about 15° C. to 35° C. (range of room temperature). However, the emulsion may also be formed at higher temperatures. To form an emulsion, the mixture is generally stirred at least 100-400 rpm, for sufficient time to form an emulsion in the presence of suitable amount of a surfactant. The time required to form an emulsion is generally less if the mixture is stirred at a higher speed.

In addition, stirring speed may even be less than 100 rpm if the stirring is continued for a sufficient amount of time.

Coloring agents and charge control agents are added with specific sequence during polymerization process over a period of time to avoid deactivation of propagation process of polymer latex.

Additional initiator may or may not be added after the seed polymerization. If additional initiator is added during this phase of the reaction, it may or may not be of the same type as the initiator added to form the latex polymer. The emulsion polymerization is generally conducted at a temperature range of about 45° C. to 120° C. with an effective time period of about 0.5 to 10 hours, preferably about 2 to 6 hours.

The emulsion particles formed though preparation of the toner has a particle diameter range of about 0.05 to 0.27 μm. If the particle diameter is smaller than 0.05 μm, the emulsion particles cannot readily extracted from the toner surface due to their high attraction property, thereby reducing developing property.

A series of emulsion polymerization experiments are listed in Table 1 below. The effects of monomer/initiator ratios and polymerization time were studied. In addition, sodium hydrogen phosphate was replaced by sodium bicarbonate as enhanced alkaline medium agent. These experiments exhibit higher degree of polymerization (conversion rate) in presence of sodium bicarbonate than sodium hydrogen phosphate. On the other hand, particle size was increased with increase of monomer/initiator ratios corresponding to increase of expected molecular weight.

### EXAMPLE 1

### Preparation of Polymerized Toner

4.0 g of colloidal silica nanoparticles (colloidal SiO₂ nanoparticles) were dissolved in 100 g of distilled water in a 250 mL reactor. Conventional surfactant was added. A ratio amount of colloidal silica nanoparticles to conventional surfactant was 1:1.2. The reactor was heated to the reaction temperature of 70° C. before adding 4.0 g of the mixture of colloidal silica nanoparticles and conventional surfactant to prepare a water-based emulsification medium.

In three-neck double jacket flask, 180 g of styrene and 38 g of n-butyl acrylate were used as monomers to prepare a copolymer resin. The copolymer resin was added to the water-based dispersion prepared above in the reactor.

Then, 4.3 g of allyl methacrylate (cross-linking agent), and 0.03 g of n-dodecylmercaptan (chain transfer agent) were added to the reactor. Thereafter, 1.1 g of a nigrosine (charge control agent) was added to the reactor and allowed to be completely dissolved, and 7.0 g of selected type of carbon black was added.

The mixture in the reactor was stirred with a mechanical stirrer at 1500 rpm for 1 hour. Then, the mixture was heated to 75° C. using a hot water circulated pump.

Then, 1.9 g of azobisisobutyronitrile (polymer initiator) was added to the resulting monomer/pigment mixture. The reaction mixture was stirred for 15 minutes at 10,000 rpm using an ultra-turaxx homogenizer. Then, reaction was allowed to continue at 75° C. for 8 hours, stirring at 800 rpm using head stirrer. Thereafter, 5.2 g of divinylbenzene (cross-linking agent) was added and stifling was allowed to continue for 10 minutes at 75° C. The polymerized toner material was thus obtained.

The polymerized toner material was refined through centrifugation and decantation using a high speed centrifuge at 15,000 rpm for 11 minutes with deionized water. The process was repeated 5 times to remove any remaining silica (SiO₂) and emulsion particles. Finally, the solid yield was dried under vacuum at 40° C. overnight to obtain dry polymerized toner material.

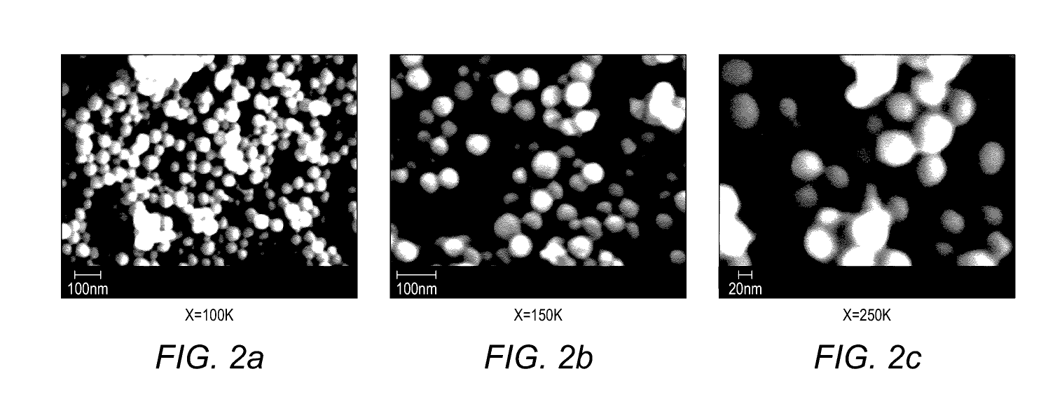

Particle size and shape of the prepared polymerized toner were investigated by using a Malvern-Zetasizer (dynamic light scattering, DLS), TEM and SEM instruments as shown in FIG. 2a, FIG. 2b and FIG. 2c.

Various concentrations of the water-based emulsification medium or water-based dispersion (mixture of colloidal silica nanoparticles and conventional surfactant) were used and the diameter of the emulsion particles was measured. The results are outlined in Table 1 below.

Also, various centrifuge cycling runs were investigated.

TABLE 1

| | Amount of | Time of | Particle | | |
|---|---|---|---|---|---|
| | emulsifier | centrifuge | size (nm) | | Conversion |
| Sample | (g) | (min.) | DLS | SEM | rate (%) |
| Example 1 | 8 | 11 | 85 | 78 | 89 |
| Example 2 | 6 | 15 | 109 | 93 | 94 |
| Example 3 | 4 | 9 | 135 | 107 | 100 |
| Example 4 | 8 | 11 | 121 | 111 | 96 |
| Example 5 | 6 | 15 | 153 | 122 | 97 |
| Example 6 | 4 | 9 | 223 | 209 | 88 |
| Example 7 | 8 | 11 | 256 | 200 | 99 |
| Example 8 | 4 | 20 | 298 | 272 | 95 |

### EXAMPLE 2

A polymerized toner material was prepared as described above in Example 1. In this example, the monomers used were styrene and hydroxyethyl methacrylate. The amount of water-based emulsification medium or water-based dispersion (mixture of colloidal silica nanoparticles and conventional surfactant) was 25% less than the amount used in Example 1.

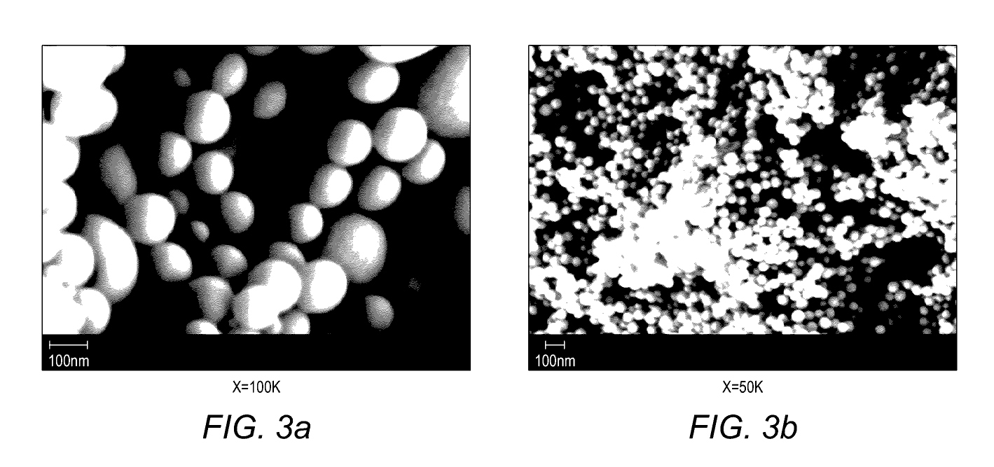

Particle size and shape of the prepared polymerized toner were investigated by using a Malvern-Zetasizer (dynamic light scattering, DLS), TEM and SEM instruments as shown in FIG. 3a and FIG. 3b.

### EXAMPLE 3

### High Loading Pigment Dispersion in Toner Particles

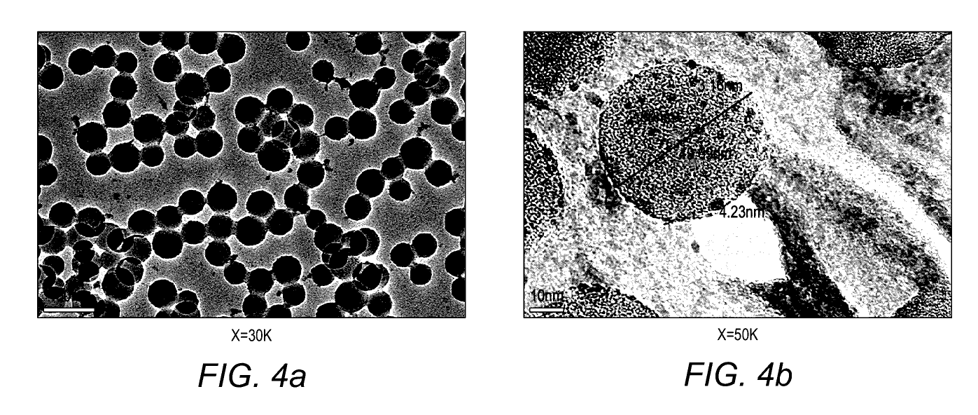

A polymerized toner material was prepared as described above in Example 1. In this example, elevated amounts of the coloring agent, carbon black, were used. It should be mentioned that one of the several key elements which allowed for commercialization of polymerized toners for the first time in the world is encapsulation of coloring agent in polymerized toner particles. It is known that carbon black tends to accumulate near the surface of toner particles. When this happens, tribo-electric charge cannot be retained and good printing images are lost. In this example, increasing the concentration of carbon black resulted in homogenous distribution over toner particles as shown in FIG. 4a and FIG. 4b (TEM investigation).

Modified polymerization technique of different copolymers which used as encapsulated resin in prospected toner particles were investigated with multi verification and characterization techniques. Emulsion polymerizations was used to prepare different encapsulated CB with copolymers in presence of colloidal silica nanoparticles as combined emulsifier medium. In addition, many types CB with different particle sizes and pH values were used as inorganic pigment in encapsulation reaction with desired copolymer. Commercial CB toner grade was applied in encapsulation systems in presence and absence of selected charge control agents.

Molar ratios, thermal behavior, particle size investigation using dynamic light scattering (DLS) measurement was determined for different copolymer samples in presence and absence of CB. The shape and size of prepared encapsulated particles were investigated with SEM and TEM and exhibited a nice spherical shape with comparable radii.

In addition, thermal behavior of prepared polymerized toner was examined with TGA and DSC. The main conclusion of thermal measurement is reflected good control in designing copolymer resin to fulfill desirable glass transition temperature in the range 79-180° C. Thermal stability of prepared copolymer is presented in narrow range 370-430° C. with weight loss 1-4% before the main thermal degradation stage.

Molar ratios of prepared copolymer resin were also considered and its effect on the prospected particle size is perfectly applied on different copolymer series. Also, PDI can be presence degree of control of polymerization through emulsion preparation technique with determined values 1.2-3.4. Pre-homogenization time and speed of reactants may be help to modified PDI of prepared polymer resin more than common known for emulsion polymerization technique.

Over all, polymerized toner particles are successfully prepared based on wide range of co-monomers to establish desirable properties for a resin as the main component in polymerized toner. Full characterized investigations were evaluated with SEC, TGA, DSC, DLS, SEM and TEM for prepared copolymer resins. Combining eco-friendly silicon (Si) nanoparticles emulsifier with traditional ones adds a sense value to the impact of this disclosure. Additionally, huge groups of toner additives (coloring agent, CCA, wax, etc.) were used from pure, commercial and novel types as a full scan for their behavior in polymerized toner formulation.

Although the present embodiments have been described with reference to specific example embodiments, it will be evident that various modifications and changes may be made to these embodiments without departing from the broader spirit and scope of the various embodiments.

The present disclosure refers to a number of documents, the content of which is herein incorporated by reference in their entirety.

### INDUSTRIAL APPLICABILITY

The process for preparing a polymerized toner material involves water-based dispersant comprising silicon (Si) nanoparticles. The silicon (Si) nanoparticles used in this disclosure can be modified silicon (Si) nanoparticles, which are non-toxic. Indeed, such particles have been declared edible by the FDA. Accordingly, the process of this invention is environmentally friendly, and the material obtained is less harmful for human health.

The specification and drawings are to be regarded in an illustrative rather than a restrictive sense.

What is claimed is:

1. A process for preparing a polymerized toner material, comprising an emulsion polymerization process involving a water-based dispersion medium which comprises silicon (Si) nanoparticles.

2. The process according to claim 1, wherein the silicon (Si) nanoparticles are selected from the group consisting of colloidal silica (SiO₂) nanoparticles and modified amphiphilic silicon (Si) particles.

3. The process according to claim 1, wherein the silicon (Si) nanoparticles are colloidal silica (SiO₂) nanoparticles.

4. The process according to claim 1, wherein the water-based dispersion medium comprises a mixture of silicon (Si) nanoparticles and at least one conventional dispersant.

5. A process for preparing a polymerized toner material, comprising a step of (a) mixing together and allowing to react: a water-based dispersion medium comprising silicon (Si) nanoparticles and at least one conventional dispersant, a polymer resin comprising one type of monomers or more, a coloring agent, and a charge control agent.

6. The process according to claim 5, wherein the water-based dispersion medium is obtained by (a1) mixing together silicon (Si) nanoparticles and at least one conventional dispersant.

7. The process according to claim 5, wherein the polymer resin is obtained by (a2) mixing together the monomers and a chain transfer agent.

8. The process according to claim 5, further comprising: (b) submitting the polymerized toner material obtained to centrifugation and decantation; and (c) drying the polymerized toner material, optionally, step (b) is performed up to eight times.

9. The process according to claim 5, wherein the mixture further comprises at least one toner additive selected from the group consisting of: polymer initiator, cross-linking agent, wax, hydrophobic silica, organic super-fine particles and enhanced alkaline medium agent.

10. The process according to claim 5, wherein step (a) is performed under stirring.

11. The process according to claim 5, wherein step (a) is performed at a temperature of about 60-90° C.

12. The process according to claim 5, wherein step (a) is performed during a period of about 7-12 hours.

13. The process according to claim 5, wherein after about 1 hour, a polymer initiator is added and the reaction is allowed to continue during a period of about 6-10 hours.

14. The process according to claim 5, wherein the silicon (Si) nanoparticles are selected from the group consisting of colloidal silica (SiO₂) nanoparticles and modified amphiphilic silicon (Si) particles; and the at least one conventional dispersant is selected from the group consisting of a fatty acid, sodium dodecyl sulfate, sodium lauryl sulfate, sodium olate, alpha olefin sulfonate, an alkylsulfate ester salt, an alkyl aryl sulfate ester salt, a dialkyl sulfosuccinate and an alkyl phosphate.

15. The process according to claim 5, wherein the monomers are selected from the group consisting of acrylate, n-butyl acrylate, methyl acrylate, ethyl acrylate, isobutyl acrylate, glycidyl methacrylate, 2-ethylhexyl acrylate, methacrylate, methyl methacrylate, ethyl methacrylate, n-butyl methacrylate, isobutyl methacrylate, dodecyl methacrylate and 2-ethylhexyl methacrylate.

16. The process according to claim 5, wherein the coloring agent is selected from the group consisting of carbon black and carbon nanotube.

17. The process according to claim 5, wherein the charge control agent is selected from the group consisting of positive charge control agent and negative charge control agent.

18. The process according to claim 5, wherein a ratio of the silicon (Si) nanoparticles to the at least one conventional dispersant in the water-based dispersion medium is about 1:1.1-1.6.

19. The process according to claim 5, wherein: an amount of the water-based dispersion medium is about 0.1-15 wt % of the monomers; an amount of coloring agent is about 1-10 wt % of the monomers; and an amount of charge control agent is about 0.1-7 wt % of the monomers.

20. A polymerized toner material obtained by a process which comprises a step of (a) mixing together and allowing to react: a water-based dispersion medium comprising silicon (Si) nanoparticles and at least one conventional dispersant, a polymer resin comprising one type of monomers or more, a coloring agent, and a charge control agent.
